(19) United States
(12) Patent Application Publication
(10) Pub. No.: US 2026/0285396 A1
(43) Pub. Date: Sep. 24, 2026

(54) STEERING ACUTATING DEVICE

(71) Applicant: KNORR-BREMSE SYSTEME FÜR NUTZ FAHRZEUGE GMBH, München (DE)

(72) Inventors: Peter Heimbrock, München (DE); Falk Hecker, Markgröningen (DE); Klaus Peterreins, München (DE)

(21) Appl. No.: 19/474,858

(22) PCT Filed: Mar. 21, 2024
(86) PCT No.: PCT/EP2024/057567

§ 371 Date: Oct. 13, 2025

(30) Foreign Application Priority Data
Apr. 14, 2023 (DE) 10 2023 109 485.8

(51) Int. Cl. B62D 5/12; B62D 5/065; B62D 5/09

(52) U.S. Cl. CPC B62D 5/12; B62D 5/065; B62D 5/091

(57) ABSTRACT

A steering actuating device for a vehicle, wherein the steering actuating device includes a hydraulic drive unit, conversion unit, an output element which is designed to impress an output torque or an output force onto a steering mechanism, wherein the hydraulic drive unit is fluidically connected to the conversion unit so that the hydraulic drive unit can apply hydraulic pressure to the conversion unit, and wherein the conversion unit has a piston and a transmission unit, wherein the piston, when the hydraulic pressure is applied to it, introduces a piston force into the transmission unit, and the transmission unit impresses the output torque or the output force onto the output element in response to the piston force introduced.

The present invention relates to a steering actuating device, to a steering system and to a vehicle.

The progressive electrification of drives for road vehicles and especially commercial vehicles is leading to progress also in the electrification of subsystems of the vehicle, such as a steering system comprising steered wheels, since higher electric power outputs than in conventionally driven vehicles are now available, and these are also suitable for operating such subsystems. Other drivers of the electrification of subsystems are rising legal requirements relating to CO2 reductions and the implementation of driving assistance functions. It is therefore precisely in steering systems that development towards electromechanical steering systems is occurring.

However, such electromechanical steering systems must be of relatively large construction to impress the necessary output torque or the necessary output force on a steering mechanism in order to actuate the steering, leading ultimately to a steering deflection of the steered wheels of the vehicle. Since the transmission of the required output torque or the required output force to the steering mechanism also requires the provision of mechanical connections, this gives rise to difficulties in accommodating the electromechanical steering systems in the installation space on the vehicle. In addition to the electromechanical steering systems, the prior art also includes hydraulic steering systems which are used in conventionally driven vehicles. In this case, a pump connected to the internal combustion engine is operated continuously in order to generate the required hydraulic pressure, this being in conflict with energy-efficient operation of the steering system as the pump is operated even when no output torque or no output force has to be impressed on the steering mechanism.

It is therefore the object of the present invention to make available a steering actuating device, a steering system and a vehicle which enable at least one of the problems described above to be solved.

This object is achieved by the subject matter of the independent claims. Advantageous further developments form the subject matter of the dependent claims.

According to the invention, a steering actuating device for a vehicle is provided, wherein the steering actuating device comprises the following:
a hydraulic drive unit,
a conversion unit,
an output element, which is designed to impress an output torque or an output force on a steering mechanism, wherein
the hydraulic drive unit is fluidically connected to the conversion unit, thus enabling the hydraulic drive unit to apply hydraulic pressure to the conversion unit, and wherein
the conversion unit has a piston and a transmission unit, wherein, when the hydraulic pressure is applied to the piston, it introduces a piston force into the transmission unit, and, in response to the piston force introduced, the transmission unit impresses the output torque or the output force on the output element.

The piston of the conversion unit is preferably provided in such a way that it can be supplied from both sides with pressure by the hydraulic drive unit. This enables a bidirectional action on the piston, and it is possible to impress the output torque or the output force on the output element in a first direction or, conversely, in a second direction, depending on the pressure application. Thus, the output torque or output force can be output with a different sign.

The piston is preferably guided in a pressure chamber, wherein the application of pressure to the piston can be accomplished by the delivery of working medium to this pressure chamber. If the piston concerned is one which can be acted upon from both sides, a pressure chamber in which the piston is guided is advantageously provided on both sides of the piston. In this case, therefore, the movement of the piston changes the volume of the two pressure chambers. If the piston moves in such a way that the first of the two pressure chambers increases in size, the second pressure chamber is simultaneously reduced in size.

The working medium can be delivered by the hydraulic drive unit.

Alternatively, it is also possible to conceive of embodiments that have pistons which are provided in such a way that pressure can be applied from one side, thereby enabling the corresponding piston force to be introduced into the transmission unit. In this case, two pistons can be provided, wherein pressure is applied selectively to just one of the two pistons in order to generate the required output torque or the required output force. The selective application of pressure to individual pressure chambers of the steering actuating device and, in particular, of the conversion unit can be controlled by a valve which directs working medium to the intended pressure chambers according to the valve position. The valve can be part of the drive unit or of the conversion unit, or can be arranged in a fluidic connection between the drive unit and the conversion unit.

The conversion unit is preferably arranged between the piston and the output element. In particular, it serves to absorb the piston force and to generate therefrom the output torque or the output force, which is then impressed on the output element. Provision can preferably be made for part of the transmission unit to be formed integrally with the piston or to be connected to the piston to form a unit.

The output element can be designed as an element that can be moved in translation. As an alternative, however, it can be designed as a rotatable shaft or can have a rotatable shaft. The output element is preferably designed as a Pitman arm, or it has a Pitman arm. This can be connected to the shaft of the output element.

In particular, the transmission unit can have a gear, by means of which the piston force is converted into a torque, which is then impressed on the output element. For this purpose, the transmission unit, in particular the gear, can have a mechanism which is designed for the conversion of a translational movement into a rotary movement. In particular, such a mechanism can comprise a combination of a pinion and a rack, a lead screw and/or a ball screw, wherein that side of the respective mechanism which is moved in translation is preferably in contact with the piston directly or via intermediate elements, and the side which is moved in rotation is preferably in contact with the output element directly or via intermediate elements.

Provision can preferably be made for part of the gear of the transmission unit to be formed integrally with the piston or to be connected to the piston to form a unit. In particular, that part of the mechanism which can be moved in translation can be connected to the piston or formed integrally with the latter. For example, the rack is connected to the piston or embodied as part of the piston in that corresponding teeth that are in engagement with the corresponding pinion are formed on the piston.

The steering actuating device preferably has a module which is formed by the drive unit. For this purpose, as a particular preference, all the elements of the drive unit are provided on a common carrier element and/or in a common housing of the drive unit.

The common carrier element can be a base plate, to which all the elements of the drive unit are connected. As an alternative, however, provision can also be made for one of the elements of the drive unit to act as a common carrier element, on which at least one further element is mounted or provided. Moreover, provision can be made for at least one of the elements of the drive unit to be mounted or provided on a further element of the drive unit and for this further element, in turn, to be provided on the common carrier element.

Such a drive unit can advantageously be embodied as a separate component and independently of the steering actuating device disclosed here and below and independently of the steering system described below and of the vehicle.

By means of the embodiment of the drive unit as a module, it is possible to obtain a separate component which, in particular, facilitates the assembly and disassembly of the steering actuating device or of the drive unit within the steering actuating device.

Moreover, this has an advantageous effect on servicing since a drive unit to be serviced can be removed and serviced as a complete component, while a second drive unit can be inserted, and thus the steering actuating device can continue in operation.

As an element, the drive unit preferably has a pump for applying pressure to the conversion unit. The pump is preferably embodied as a bidirectional pump. In particular, it can have an internal gear pump or a crescent pump, or can be embodied as such a pump. In the case of a bidirectional embodiment of the pump, it is possible, depending on the delivery direction of the pump, to deliver working medium to different pressure chambers in order to apply pressure to the piston of the conversion unit from different sides. If the pump concerned is a pump that delivers unidirectionally, it is possible to provide a valve which is designed to feed working medium to one or the other pressure chamber, depending on the valve position. Such a valve can also be provided if at least two pistons are provided and the delivery of working medium is to take place selectively to the respective pressure chambers of the pistons. Such a pump is preferably in contact with a reservoir for the working medium. The reservoir can be part of the steering actuating device.

The pump of the drive unit is preferably provided in such a way as to be drivable by an electric machine, wherein the electric machine is provided as an element of the drive unit. Such an electric machine advantageously allows operation of the steering actuating device as required. That is to say, unlike conventionally driven vehicles, in which the pump is not driven by an electric machine but is driven continuously by the internal combustion engine, on demand operation of the pump is possible here since it is activated only when application of pressure to the conversion unit or the piston is actually desired. In this way, it is possible to implement significantly more energy-efficient operation in comparison with conventionally driven vehicles.

As an element, the drive unit preferably has a control device which is designed to control the drive unit, in particular the electric machine and/or the pump, to generate pressure. If the drive unit is embodied as a module, the control device can likewise be connected to the carrier element or can be provided in the housing of the drive unit.

In addition to this embodiment, it is also possible, however, for the control device to be provided separately as part of the steering actuating device. In this way, greater freedom in the placement of the control device is possible. Moreover, this makes it possible to construct a smaller drive unit.

In general, the control device can be designed as an electric or electronic control device which, in particular, outputs a control signal for controlling the drive unit or the pump of the drive unit. The control signal can correspond to the input signal, which is mentioned below.

The drive unit is preferably connected directly to the conversion unit. In this case, the drive unit and the conversion unit together form one component. In particular, this can be implemented by providing both in a common housing or by connecting the drive unit and the conversion unit to one another. This connection can be implemented by means of connecting elements such as screws, for example. In particular, provision can be made for both the drive unit and the conversion unit to have separate housings, wherein the two housings are connected to one another in order to form the separate component. Both the drive unit and the conversion unit have connections which are in contact with one another and via which the working medium for the application of hydraulic pressure to the conversion unit or the piston can be delivered. In this way, the drive unit and the conversion unit form a common component or module which can be installed or removed as a whole.

Embodying the drive unit and the conversion unit as a common component or module facilitates the assembly and disassembly of the steering actuating device. Moreover, this has an advantageous effect on servicing since a combination of a drive unit and a conversion unit to be serviced can be removed and serviced as a complete component, while a second combination can be inserted, and thus the steering actuating device can continue in operation.

Alternatively, the drive unit is provided in such a way as to be separated from the conversion unit, wherein a line connection is provided between the drive unit and the conversion unit in order to apply hydraulic pressure to the conversion unit. In this way, relatively free placement of the drive unit is possible. It does not necessarily have to be connected to the conversion unit or placed in the vicinity thereof. On the contrary, the mechanical connection to the output element or, via the output element, to the steering mechanism means that there is less freedom in the placement of the conversion unit.

Thus, the separate embodiment of the drive unit and the conversion unit enables better utilization of the installation space by the steering actuating device since the drive unit does not have to be arranged at a location predetermined by the conversion unit, as compared with embodiments in which the drive unit and the conversion unit are connected to one another. In this case, the line connection between the drive unit and the conversion unit can be routed relatively freely.

The drive unit and, in particular, the electric machine and/or the pump of the drive unit, is preferably designed to apply the hydraulic pressure to the conversion unit in response to an input signal. Such an input signal can be made available to the pump or to the electric machine by the control device of the drive unit, for example. The input signal itself can be generated from a steering command, which is transmitted to the drive unit or the steering actuating device.

The steering actuating device preferably has a detection unit, which is designed to detect a steering command. The detection unit can detect the steering command, which, in particular, is transmitted from outside to the steering actuating device. Here, the steering command itself can stem from different sources, as explained below.

The steering actuating device preferably has a driver interface in order to receive the steering command of a driver (driver steering command), wherein the detection unit is designed to convert the driver steering command into the steering command and/or to detect it as an input signal. The driver interface preferably has a steering wheel, via which a driver can generate the corresponding driver steering command by turning the steering wheel or applying a corresponding torque to the steering wheel.

The detection unit preferably has a torque sensor and/or a rotation angle sensor in order to detect the steering command. This is advantageous, particularly if the driver specifies a steering command (driver steering command) by means of the steering wheel. The driver steering command can be detected by detecting the torque applied by the driver at the steering wheel or detecting the rotation angle set there. However, it is also possible not to detect the torque directly applied by the driver or the rotation angle set. For example, a transmission ratio can be provided, such that the torque or rotation angle is detected downstream of the transmission ratio.

As an alternative or in addition, the detection unit has a data interface in order to detect the steering command. In particular, a data interface can be connected to a control system of the vehicle which is designed to control and steer the vehicle in a partially or fully automated manner. In particular, this can be a matter of control systems which are referred to among those skilled in the art as ADAS or HAD systems. Such systems can transmit steering commands directly to the steering actuating device via the data interface of the detection unit. Such a steering command can correspond to a torque or a rotation angle at a steering wheel or else may be completely different therefrom. For example, it is also possible to conceive of using the steering actuating device in vehicles that drive in a fully autonomous manner, which do not have any steering wheel or a comparable driver interface. It is therefore also possible here, via the data interface, to detect a steering command which does not in fact correspond to a torque or to a rotation angle at a steering wheel.

The detected steering command or driver steering command can be used in general as an input signal, in particular for the activation of the electric machine and/or the pump, or provision can be made for the detection unit or the control device to use it to generate a corresponding input signal in order to activate the electric machine and/or the pump. The steering actuating device preferably has a mechanical connection from the driver interface to the conversion unit, in particular to the transmission unit, via which the steering command of a driver can be impressed mechanically on the conversion unit.

This can be achieved, for example, by means of a direct mechanical drive connection which leads from the driver interface, that is to say, for example, from the steering wheel, to the steering actuating device. This can be a direct shaft connection or else a shaft connection with a gear inserted in between. As an alternative or in addition, provision can also be made for the connection to have deflections, in particular in the form of U joints and/or bevel boxes. In this way, a driver can introduce a torque into the steering actuating device or into the conversion unit directly via a mechanical route. The conversion unit is preferably designed to impress an output torque or an output force on the output element in response to the torque introduced.

To make this possible, the transmission unit provided in the conversion unit is preferably designed to perform a combination or superposition of the hydraulically introduced piston force and of the torque introduced by the driver. This can be accomplished by means of a superposition gear, for example. In particular, provision can be made for the piston to be connected to the shaft of the mechanical connection via a lead screw, a ball screw, a combination of a pinion and a rack and/or the like.

The mechanical connection from the driver interface to the conversion unit advantageously enables the implementation of a mechanical failsafe level, ensuring that, even if pressure application by the drive unit is no longer possible, e.g. because the pump, the electric machine, the control device or the drive unit as a whole is faulty, a steering command can nevertheless be introduced mechanically into the conversion unit.

However, the drive unit can also be used to supplement a torque which the driver generates via the driver interface and impresses on the conversion unit via the mechanical connection. In this case, assistance to the driver is achieved by the application of pressure to the piston.

The steering command of a driver preferably is or comprises a driver steering torque, wherein the mechanical connection has a freewheel which allows mechanical transfer of the driver steering torque to the conversion unit when the output force or the output torque of the output element is not sufficient to fulfill the driver steering command. This ensures that the torque which the driver makes available via the driver interface can be used to assist the steering actuating device.

According to one advantageous embodiment of the invention, the driver interface is implemented without a mechanical connection to the conversion unit. In this embodiment, the driver interface is preferably used as a data source via which, for example, a steering command, such as a steering angle or a steering torque, can be output to the detection unit. In such a case, the resulting steering actuating device is less complex since mechanical superposition of a torque which the driver impresses on the steering wheel with the piston force is no longer necessary.

According to the invention, a steering system for a vehicle, in particular for a commercial vehicle, is provided, which comprises the following:
at least one axle with wheels that can be steered via a steering mechanism, and
a steering actuating device of the type described above, wherein
the steering mechanism is connected to the output element of the steering actuating device.

In this way, the steerable wheels of the vehicle can be steered by operating the steering actuating device. Thus, the output torque or the output force can be impressed on the steering mechanism via the output element of the steering actuating device.

According to the invention, a vehicle, in particular a commercial vehicle, having a steering system of the kind described above is provided.

The vehicle itself is preferably embodied as a conventional vehicle, i.e. a vehicle driven by an internal combustion engine, electrically or by a hybrid system. In particular, provision can be made to enable the vehicle to drive in a partially or fully automated mode. In such a case, a control system of the vehicle, which controls the partially or fully automated operation of the vehicle, is preferably connected to the detection unit in order to send corresponding steering commands to the steering actuating device.

The invention is described below by means of preferred exemplary embodiments with reference to the appended drawings.

### IN THE DRAWINGS

FIG. 1 shows a first embodiment of the invention,

FIG. 2 shows a second embodiment of the invention,

FIG. 3 shows a third embodiment of the invention, and

FIG. 4 shows a fourth embodiment of the invention.

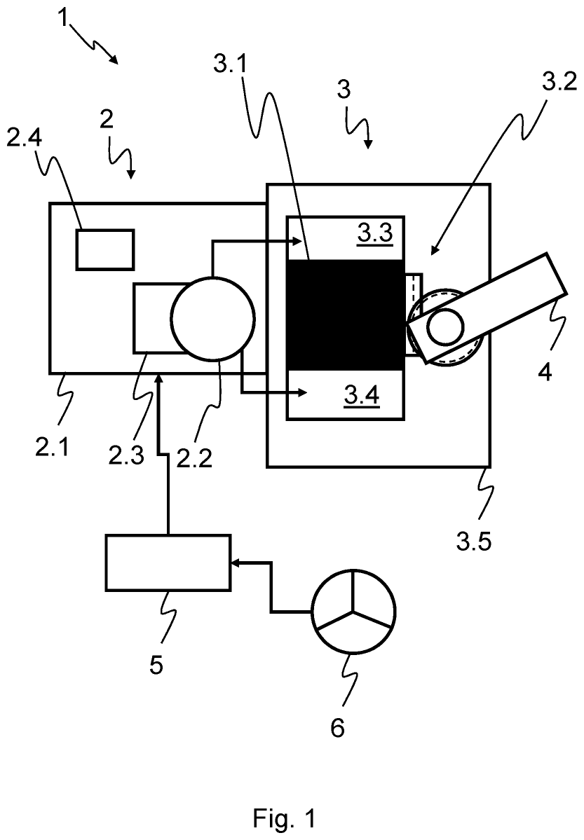

FIG. 1 shows a first embodiment of the invention.

It shows a steering actuating device 1 which has a hydraulic drive unit 2 and a conversion unit 3. In addition, the steering actuating device 1 has an output element 4, which is provided here as a rotatable element and, in particular, can be designed as a Pitman arm in order to support an output torque on a steering mechanism (not shown). The output element 4 is provided in such a way as to be rotatable in the plane of the drawing about an axis oriented perpendicularly to the plane of the drawing.

Here, the hydraulic drive unit 2 has a housing 2.1, which contains the elements of the hydraulic drive unit 2. The drive unit 2 has the following elements, wherein this enumeration should not be taken to be exhaustive: a pump 2.2, an electric machine 2.3 and a control device 2.4. The electric machine 2.3 is designed to drive the pump 2.2 in response to an input signal provided by the control device 2.4, thus enabling the pump to deliver a hydraulic working medium to the conversion unit 3. By virtue of its housing 2.1, the drive unit 2 itself is designed as a module. It is therefore designed as a separate component. The installation and removal as well as the servicing of the drive unit 2, in particular, are thereby made easier. The control device 2.4 itself can be designed as an electric or electronic control device.

The conversion unit 3 has a piston 3.1, which is provided in such a way as to be movable from the top downward and vice versa in the drawing. The piston 3.1 is provided within a cylinder, which guides the piston 3.1 during its movement. In this case, the piston 3.1 divides a first pressure chamber 3.3 from a second pressure chamber 3.4 within the cylinder. The downward movement of the piston 3.1 increases the volume of the first pressure chamber 3.3 while, at the same time, the volume of the second pressure chamber 3.4 is reduced. The upward movement of the piston 3.1 reduces the volume of the first pressure chamber 3.3 while, at the same time, the volume of the second pressure chamber 3.4 is increased.

Furthermore, the piston 3.1 is connected to a transmission unit 3.2. The transmission unit 3.2 is designed to convert a piston force generated by the application of pressure to the piston 3.1 in one of the pressure chambers 3.3, 3.4 into an output torque, which is impressed on the output element 4. For this purpose, the transmission unit 3.2 has a combination of a pinion and a rack, wherein the rack is connected to the piston 3.1 and is in engagement with the pinion, which is connected to the output element 4. A piston force is thereby transmitted via the rack to the transmission unit 3.2 and then transmitted to the pinion, thus enabling an output torque to be impressed on the output element 4.

The conversion unit 3 furthermore has a housing 3.5, in which the piston 3.1, the pressure chambers 3.3 and 3.4 as well as the transmission unit 3.2 are provided. By virtue of its housing 3.5, the conversion unit 3 itself is designed as a module. It is therefore designed as a separate component. The installation and removal as well as the servicing of the conversion unit 3, in particular, are thereby made easier.

In the embodiment shown, the hydraulic drive unit 2 and the conversion unit 3 are connected to one another in that their housings 2.1, 3.5 are directly in contact with one another. The drive unit 2 and the conversion unit 3 thus form a module or a single component. The respective connections for transmitting hydraulic working medium from the pump 2.2 to pressure chamber 3.3 or pressure chamber 3.4 are directly fluidically connected to one another through the contact between the two housings 2.1, 3.5. The pump 2.2 can thus deliver working medium directly to the pressure chambers 3.3 and 3.4. The delivery paths for the hydraulic working medium are illustrated by the two arrows which lead from the pump 2.2 to the pressure chambers 3.3 and 3.4.

In addition to the drive unit 2 and the conversion unit 3, the steering actuating device 1 has a detection unit 5. This is designed to detect a steering command. As illustrated in the drawing, the steering command can stem from a driver interface 6, which is illustrated here as a steering wheel. To detect the steering command, the detection unit 5 can have a torque sensor and/or a rotation angle sensor. The steering command can be detected by detecting the torque applied by the driver at the steering wheel or detecting the rotation angle set there. However, it is also possible not to detect the torque directly applied by the driver or the rotation angle set. For example, a transmission ratio can be provided, such that the torque or rotation angle is detected downstream of the transmission ratio.

As an alternative or in addition, the detection unit 5 has a data interface in order to detect the steering command. In particular, a data interface can be connected to a control system of the vehicle which is designed to control the vehicle in a partially or fully automated manner. Such systems can transmit steering commands directly to the steering actuating device via the data interface of the detection unit. Such a steering command can correspond to a torque or a rotation angle at a steering wheel or else may be completely different therefrom. For example, it is also possible to conceive of using the steering actuating device in vehicles that drive in a fully autonomous manner, which do not have any steering wheel or a comparable driver interface 6. It is therefore also possible here, via the data interface, to detect a steering command which does not in fact correspond to a torque or to a rotation angle at a steering wheel.

The detection unit 5 is designed to transmit the detected steering command to the drive unit 2, wherein the control device 2.4 is designed to convert the steering command into a corresponding input signal for the electric machine 2.3.

The operation of the steering actuating device 1 is as follows:

If the steering command sent to the detection unit 5 via the driver interface 6 indicates that no steering is necessary, the activation of the electric machine 2.3 by the input signal of the control device 2.4 does not occur. As a result, the pump 2.2 does not deliver any working medium to the conversion unit 3 or to one of the pressure chambers 3.3, 3.4 located there, the result being that there is no application of pressure to the piston 3.1 from the upper or lower side in the drawing. Thus, no output torque is impressed on the output element 4 via the transmission unit 3.2.

If the steering command detected by the detection unit 5 from the driver interface 6 now indicates that steering of the wheels of the vehicle should take place, the control device 2.4 generates a corresponding input signal from the steering command transmitted by the detection unit 5 to the drive unit 2, activating the electric machine 2.3, which now drives the pump 2.2. Depending on the steering command, the pump 2.2 now delivers working medium to the upper pressure chamber 3.3 or to the lower pressure chamber 3.4 in order to apply pressure in corresponding fashion to the piston 3.1. As a result, the piston 3.1 is acted upon by a corresponding piston force, which is further supported in the transmission unit 3.2. By means of the combination of the pinion and the rack, the transmission unit 3.2 converts the piston force into a corresponding output torque, which is impressed on the output element 4 and which can then be supported in a steering mechanism of the vehicle (not illustrated), as a result of which ultimately steering of the wheels of the vehicle is brought about.

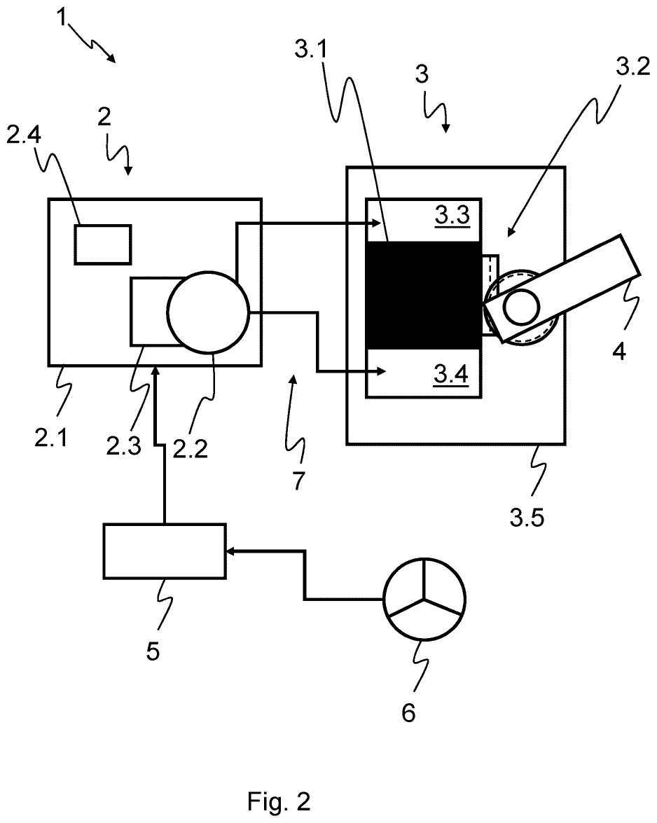

FIG. 2 shows a second embodiment of the invention.

This corresponds substantially to the embodiment shown in FIG. 1. Attention is therefore drawn to the description relating to FIG. 1. Only the differences between the two embodiments will be explored below.

Here, in contrast to the embodiment in FIG. 1, the drive unit 2 and the conversion unit 3 are not connected to one another. The two housings 2.1 and 3.5 are provided separately from one another, wherein a line connection 7 is provided between the two housings 2.1 and 3.5, thus enabling the pump 2.2 to deliver working medium to pressure chamber 3.3 or pressure chamber 3.4 via the line connection 7.

The operation of this embodiment corresponds substantially to that from FIG. 1. Here, advantages are obtained primarily through the greater freedom of arrangement of the drive unit 2 and the conversion unit 3 since the line connection 7 can be routed relatively freely in the vehicle. Thus, the drive unit 2 and the conversion unit 3 can be positioned on locations in the vehicle that are advantageous for this purpose.

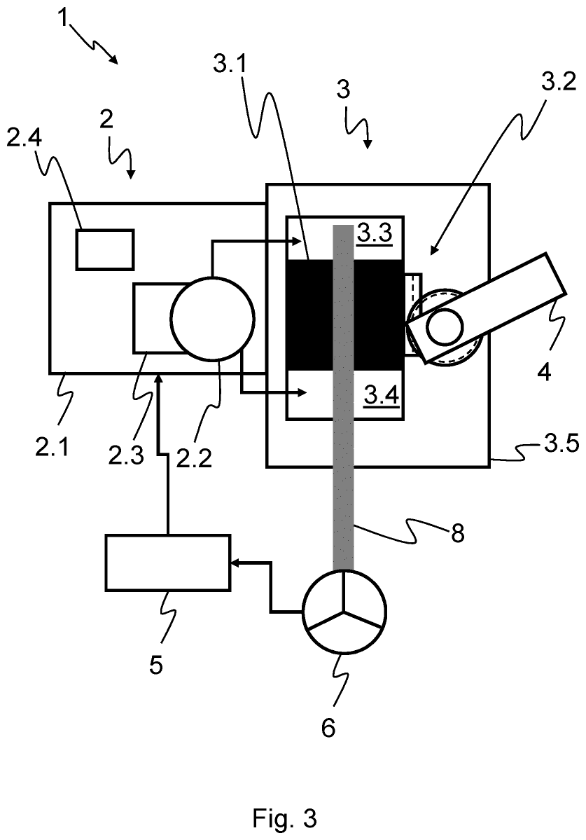

FIG. 3 shows a third embodiment of the invention.

This corresponds substantially to the embodiment from FIG. 1. Attention is therefore drawn to the description relating to FIG. 1.

Supplementing the embodiment shown in FIG. 1, the steering actuating device 1 has a mechanical connection 8 to the driver interface 6. Via the driver interface 6, a torque can thus be impressed on the connection 8, and this can be introduced into the conversion unit 3. Here, the mechanical connection 8 is embodied as a shaft, which is connected to the piston 3.1. Between the piston 3.1 and the shaft, a gear (not shown) is provided, which is designed to convert the torque impressed on the shaft by the driver interface 6 into a force which acts on the piston 3.1. Just like a piston force which is generated by applying pressure to the piston 3.1, this force acts parallel to a vertical line running from the top down in the drawing. To convert the torque which has been impressed on the shaft by the driver interface 6, the gear can have a ball screw, a lead screw or the like.

The mechanical connection 8 from the driver interface 6 to the conversion unit 3 thus enables the implementation of a mechanical failsafe level, ensuring that, even if pressure application to the piston 3.1 by the drive unit 2 is no longer possible, e.g. because the pump 2.2 or the drive unit 2 as a whole is faulty, a force can nevertheless be applied mechanically to the piston 3.1.

In this embodiment, however, it is also possible for the torque introduced mechanically via the shaft of the mechanical connection 8, or the force which results therefrom and is applied to the piston 3.1, to be assisted by the additional application of hydraulic pressure to the piston 3.1 by the pump 2.2, ensuring that a driver is to apply lower forces at the driver interface 6 to steer the vehicle.

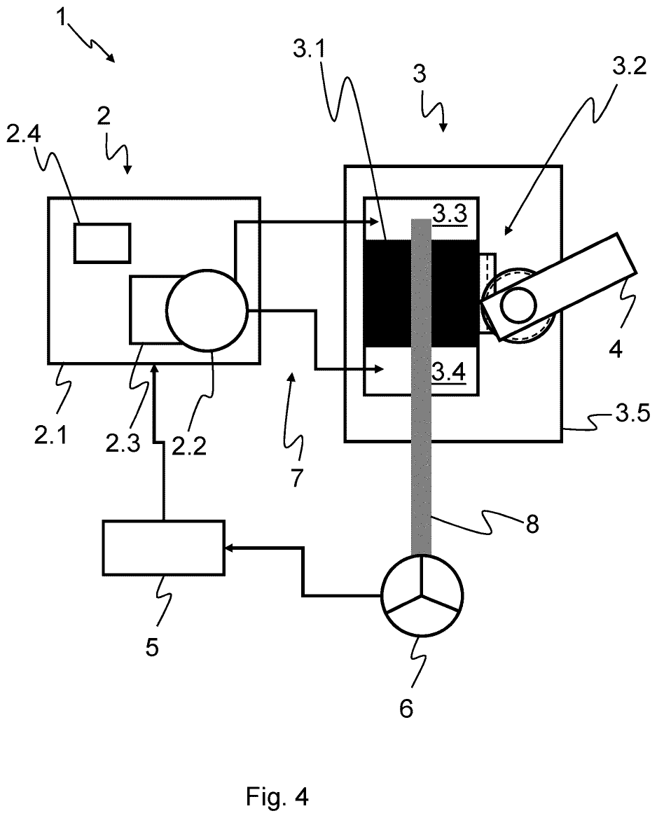

FIG. 4 shows a fourth embodiment of the invention.

This embodiment corresponds substantially to a further development of the embodiment from FIG. 2 since, in this case, the drive unit 2 and the conversion unit 3 are embodied separately from one another and are connected fluidically to one another via a line connection 7. Here too, the mechanical connection 8 from FIG. 3 is provided in addition, connecting the driver interface 6 to the conversion unit 3. Since the mechanical connection 8 corresponds in terms of embodiment and operation to that from FIG. 3, attention is drawn in this regard to the corresponding description relating to FIG. 3.

In the drawings described above, a driver interface 6 in the form of the steering wheel is shown in all cases. However, this may no longer be present in future vehicles if they are operated autonomously. The detection unit 5 then receives a steering command exclusively from other control systems.

In another embodiment (not shown), which can be based, in particular, on one of the drawings in FIGS. 1 to 4, the piston 3.1 is formed integrally with the rack of the transmission unit 3.2. In this case, the teeth of the rack can be formed on the surface of the piston 3.1.

Ultimately, the invention makes available an electrohydraulic steering actuating device 1 which, on the one hand, has the advantages of energy-efficient operation, since the application of pressure to the conversion unit 3 or to the piston 3.1 takes place only when it is actually necessary, i.e. the pump 2.2 of the drive unit 2 need then only be operated when pressure is required. In addition, the use of the hydraulic components allows a relatively high transmission ratio of forces and torques with, at the same time, a space-saving construction and flexible possibilities for the arrangement of the components of the steering actuating device 1 as compared with an electromechanical solution.

### LIST OF REFERENCE SIGNS

1 steering actuating device
2 hydraulic drive unit
2.1 housing
2.2 pump
2.3 electric machine
2.4 control device
3 conversion unit
3.1 piston
3.2 transmission unit
3.3 pressure chamber
3.4 pressure chamber
3.5 housing
4 output element
5 detection unit
6 driver interface
7 line connection
8 mechanical connection

1. A steering actuating device for a vehicle, comprising:
a hydraulic drive unit,
a conversion unit,
an output element, which is designed to impress an output torque or an output force on a steering mechanism, wherein
the hydraulic drive unit is fluidically connected to the conversion unit, thus enabling the hydraulic drive unit to apply hydraulic pressure to the conversion unit, and wherein
the conversion unit has a piston and a transmission unit, wherein, when the hydraulic pressure is applied to the piston, it introduces a piston force into the transmission unit, and, in response to the piston force introduced, the transmission unit impresses the output torque or the output force on the output element.

2. The steering actuating device as claimed in claim 1, wherein the steering actuating device has a module which is formed by the drive unit, and all the elements of the drive unit are provided on a common carrier element and/or in a common housing of the drive unit.

3. The steering actuating device as claimed in claim 1, wherein as an element, the drive unit has a pump for applying pressure to the conversion unit.

4. The steering actuating device as claimed in claim 3, wherein the pump is provided in such a way as to be drivable by an electric machine, wherein the electric machine is provided as an element of the drive unit, and/or
wherein the drive unit has as an element a control device which is designed to control the drive unit to generate pressure.

5. The steering actuating device as claimed in claim 1, wherein the drive unit is connected directly to the conversion unit.

6. The steering actuating device as claimed in one of claim 1, wherein the drive unit is provided in such a way as to be separated from the conversion unit, wherein a line connection is provided between the drive unit and the conversion unit in order to apply hydraulic pressure to the conversion unit.

7. The steering actuating device as claimed in one of claim 1, wherein the drive unit is designed to apply the hydraulic pressure to the conversion unit in response to an input signal.

8. The steering actuating device as claimed in claim 7, comprising a detection unit which is designed to detect a steering command.

9. The steering actuating device as claimed in claim 8, comprising a driver interface in order to receive the steering command of a driver, wherein the detection unit is designed to convert the steering command of the driver into the steering command and/or to detect it as a steering command.

10. The steering actuating device as claimed in claim 8, wherein the detection unit has a torque sensor, a rotation angle sensor and/or a data interface in order to detect the steering command.

11. The steering actuating device as claimed in claim 9, comprising a mechanical connection from the driver interface to the conversion unit, in particular to the transmission unit, via which the steering command of a driver can be impressed mechanically on the conversion unit

12. The steering actuating device as claimed in claim 11, wherein the steering command of a driver is or comprises a driver steering torque, and the mechanical connection has a freewheel which allows mechanical transfer of the driver steering torque to the conversion unit when the output force or the output torque of the output element is not sufficient to fulfill the driver steering command.

13. The steering actuating device as claimed in claim 9, wherein the driver interface is implemented without a mechanical connection to the conversion unit.

14. A steering system for a vehicle, in particular a commercial vehicle, comprising:
at least one axle with wheels that can be steered via a steering mechanism, and
the steering actuating device as claimed in claim 1,
wherein the steering mechanism is connected to the output element of the steering actuating device

15. A vehicle, in particular a commercial vehicle, having the steering system as claimed in claim 14.
